(19) United States
(12) Patent Application Publication
(10) Pub. No.: US 2025/0246743 A1
(43) Pub. Date: Jul. 31, 2025

(54) BATTERY MODULE

(71) Applicant: Prime Planet Energy & Solutions, Inc., Tokyo (JP)

(72) Inventors: Tetsuji OMURA, Kobe-shi (JP); Nao KOGAMI, Himeji-shi (JP)

(21) Appl. No.: 19/021,165

(22) Filed: Jan. 15, 2025

(30) Foreign Application Priority Data
Jan. 30, 2024 (JP) 2024-011525

(51) Int. Cl. H01M 50/291

(52) U.S. Cl. CPC H01M 50/291

(57) ABSTRACT

This separator includes a main body portion and an embedded portion embedded in each of a plurality of through holes provided in the main body portion, the main body portion is a heat insulating material having heat insulating performance higher than that of the embedded portion, the embedded portion is an elastic material having elastic performance higher than that of the main body portion, and a shortest distance between one portion of an inner wall surface of an inner diameter of the through hole and another portion of the inner wall surface of the inner diameter of the through hole is 60 mm or less, the other portion of the inner wall surface being located in a direction perpendicular to the one portion of the inner wall surface.

### CROSS REFERENCE TO RELATED APPLICATIONS

This nonprovisional application is based on Japanese Patent Application No. 2024-011525 filed on Jan. 30, 2024 with the Japan Patent Office, the entire contents of which are hereby incorporated by reference.

### BACKGROUND OF THE INVENTION

### Field of the Invention

The present technology relates to a battery module.

### Description of the Background Art

Japanese Patent Laying-Open No. 2021-140968 is a prior art document that discloses a configuration of a heat insulating material for a battery module. The heat insulating material described in Japanese Patent Laying-Open No. 2021-140968 includes a heat insulating portion disposed to face a surface of a battery cell, and a cushioning portion that is more likely to be compressively deformed than the heat insulating portion, wherein at least a portion of the cushioning portion is disposed at a position close to the surface of the battery with respect to the heat insulating portion.

### SUMMARY OF THE INVENTION

In the heat insulating material described in Japanese Patent Laying-Open No. 2021-140968, the heat insulating portion and the cushioning portion, which is more likely to be compressively deformed than the heat insulating portion, are provided to improve followability at the time of deformation of the heat insulating material. However, no review has been made with regard to a case where the temperature of the battery cell becomes high to result in that the cushioning portion ceases to exist, in addition to the deformation of the battery cell.

The present technology has been made to solve the above-described problem, and has an object to provide a battery module including a separator that can maintain a function as a heat insulating material at each of the time of deformation of a battery cell and the time of high temperature of the battery cell.

The present technology provides the following battery module.
[1] A battery module comprising: a plurality of battery cells arranged side by side in a first direction; and a separator sandwiched between the plurality of battery cells, wherein the separator includes a main body portion, and an embedded portion embedded in each of a plurality of through holes provided in the main body portion, the main body portion is a heat insulating material having heat insulating performance higher than heat insulating performance of the embedded portion, the embedded portion is an elastic material having elastic performance higher than elastic performance of the main body portion, and a shortest distance between one portion of an inner wall surface of an inner diameter of the through hole and another portion of the inner wall surface of the inner diameter of the through hole is 60 mm or less, the other portion of the inner wall surface being located in a direction perpendicular to the one portion of the inner wall surface.
[2] The battery module according to [1], wherein a length of the embedded portion is longer than a length of the main body portion in the first direction.
[3] The battery module according to [1] or [2], wherein the embedded portion is melted at a predetermined temperature or more, and the main body portion is not melted at the predetermined temperature or more.
[4] The battery module according to any one of [1] to [3], wherein when viewed in the first direction, the embedded portion is shaped to have any of a solid circular shape, a solid elliptical shape, a solid cross shape, a hollow circular shape, or a hollow elliptical shape.
[5] The battery module according to any one of [1] to [4], wherein when viewed in the first direction, the embedded portion is shaped to have a first region and a second region, the first region extending in a second direction included in an imaginary plane orthogonal to the first direction when viewed in the imaginary plane, the second region extending in a third direction included in the imaginary plane and orthogonal to the second direction.
[6] The battery module according to any one of [1] to [5], wherein the separator is covered with a laminate film.

The foregoing and other objects, features, aspects and advantages of the present invention will become more apparent from the following detailed description of the present invention when taken in conjunction with the accompanying drawings.

### BRIEF DESCRIPTION OF THE DRAWINGS

FIG. 1 is a perspective view showing a configuration of a battery module according to a first embodiment.

FIG. 2 is a perspective view showing an internal configuration of the battery module according to the first embodiment.

FIG. 3 is a perspective view showing a configuration of a battery cell of the battery module according to the first embodiment.

FIG. 4 is a perspective view showing a configuration of a separator of the battery module according to the first embodiment.

FIG. 5 is a cross sectional view along a line V-V in FIG. 4.

FIG. 6 is a schematic diagram of a first state (normal state) in which a separator is sandwiched between battery cells.

FIG. 7 is a schematic diagram of a second state (expansion state) in which the separator is sandwiched between the battery cells.

FIG. 8 is a first schematic cross sectional view showing a relation between an amount of deformation of the battery cell and a hole diameter of a through hole.

FIG. 9 is a second schematic cross sectional view showing the relation between the amount of deformation of the battery cell and the hole diameter of the through hole.

FIG. 10 is a diagram showing the relation between the diameter of the through hole and the amount of deformation of the battery cell.

FIG. 11 is a cross sectional view showing a configuration of a separator according to a second embodiment.

FIG. 12 is a cross sectional view showing a configuration of a separator according to a third embodiment.

FIG. 13 is a side view showing a configuration of a separator according to a fourth embodiment.

FIG. 14 is a side view showing a configuration of a separator according to a fifth embodiment.

FIG. 15 is a side view showing a configuration of a separator according to a sixth embodiment.

FIG. 16 is a side view showing a configuration of a separator according to a seventh embodiment.

FIG. 17 is a cross sectional view showing a configuration of a separator according to an eighth embodiment.

FIG. 18 is a cross sectional view showing a configuration of a separator according to a ninth embodiment.

FIG. 19 is a cross sectional view showing a configuration of a separator according to a tenth embodiment.

### DESCRIPTION OF THE PREFERRED EMBODIMENTS

Hereinafter, embodiments of the present technology will be described. It should be noted that the same or corresponding portions are denoted by the same reference characters, and may not be described repeatedly.

In the embodiments described below, when reference is made to number, amount, and the like, the scope of the present technology is not necessarily limited to the number, amount, and the like unless otherwise stated particularly. In the embodiments described below, each component is not necessarily essential to the present technology unless otherwise stated particularly. The present technology is not limited to one that necessarily exhibits all the functions and effects stated in the present embodiment.

In the present specification, the terms “comprise”, “include”, and “have” are open-end terms. That is, when a certain configuration is included, a configuration other than the foregoing configuration may or may not be included.

In the present specification, when geometric terms and terms representing positional/directional relations are used, for example, when terms such as “parallel”, “orthogonal”, “obliquely at 45°”, “coaxial”, and “along” are used, these terms permit manufacturing errors or slight fluctuations. In the present specification, when terms representing relative positional relations such as “upper side” and “lower side” are used, each of these terms is used to indicate a relative positional relation in one state, and the relative positional relation may be reversed or turned at any angle in accordance with an installation direction of each mechanism (for example, the entire mechanism is reversed upside down).

In the present specification, the term “battery” is not limited to a lithium ion battery, and may include other batteries such as a nickel-metal hydride battery and a sodium-ion battery. In the present specification, the term “electrode” may collectively represent a positive electrode and a negative electrode.

The “battery module” can be mounted on vehicles such as a hybrid electric vehicle (HEV), a plug-in hybrid electric vehicle (PHEV), and a battery electric vehicle (BEV). It should be noted that the use of the “battery module” is not limited to the use in a vehicle.

In each of the figures, a Y direction serving as a first direction is defined as a direction in which a plurality of battery cells are arranged side by side, a second direction (X direction) is defined as a direction which is included in an imaginary plane orthogonal to the first direction when viewed in the imaginary plane and in which positive electrode terminal and negative electrode terminal of each battery cell are arranged side by side, and a third direction (Z direction) is defined as a direction which is included in the imaginary plane and orthogonal to the second direction and in which upper and lower surfaces of the battery cell are arranged side by side. In order to facilitate understanding of the present technology, the size of each configuration in the figures may be illustrated to be changed from its actual size.

### First Embodiment

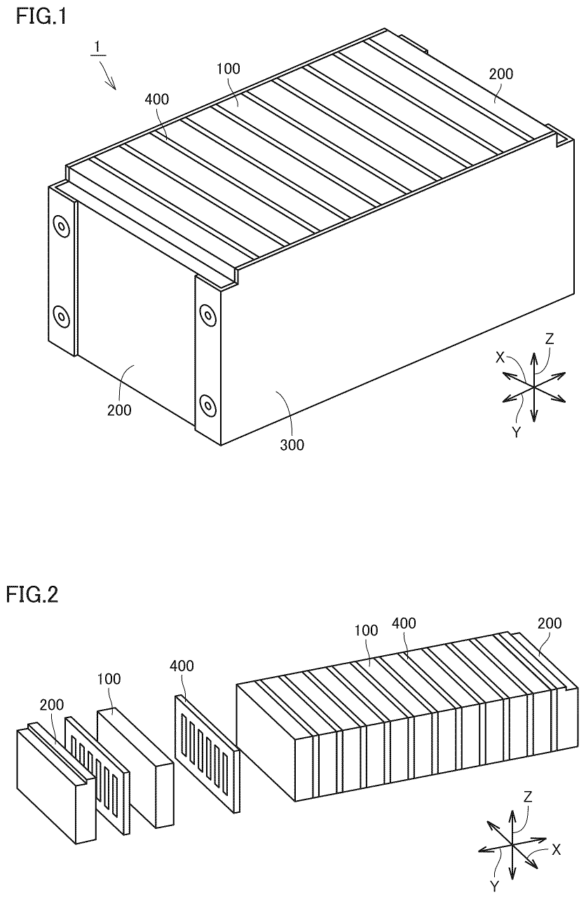

A configuration of a battery module according to a first embodiment will be described. FIG. 1 is a perspective view showing a configuration of a battery module 1, and FIG. 2 is a perspective view showing an internal configuration of battery module 1.

Referring to FIGS. 1 and 2, battery module 1 includes battery cells 100, end plates 200, restraint members 300, and separators 400.

The plurality of battery cells 100 are arranged side by side in the first direction (Y direction). Each separator 400 described below is disposed between battery cells 100. The plurality of battery cells 100, which are sandwiched between two end plates 200, are pressed by end plates 200 with separators 400 being interposed therebetween, and are therefore restrained between two end plates 200.

End plates 200 are provided at both ends of the plurality of battery cells 100 in the first direction (Y direction). Each of end plates 200 is fixed to a base such as a housing that accommodates battery module 1. End plate 200 is composed of, for example, aluminum or iron.

Referring to FIG. 1, restraint members 300 are provided at both ends of the plurality of battery cells 100 and end plates 200 in the X direction. When each of restraint members 300 is engaged with end plates 200 with compressive force in the Y direction being applied to the plurality of stacked battery cells 100 and end plates 200 and then the compressive force is released, tensile force acts on restraint member 300 that connects two end plates 200. As a reaction thereto, restraint member 300 presses two end plates 200 in directions of bringing them closer to each other. As a result, restraint member 300 restrains the plurality of battery cells 100 in the Y direction.

Separators 400 are disposed between the plurality of battery cells 100. A separator 400 is disposed between an end plate 200 and a battery cell 100 located at an end portion in the Y direction and included in the plurality of battery cells 100. Separators 400 are in abutment with the long side surfaces of the plurality of battery cells 100 or the long side surfaces of end plates 200.

Each of separators 400 has an insulating property. Thus, separator 400 insulates the plurality of battery cells 100 from each other or insulates battery cell 100 from end plate 200. Details of separator 400 will be described later.

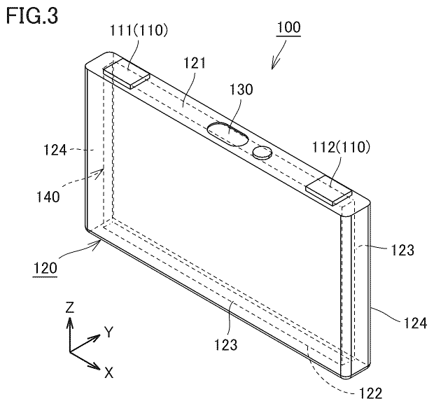

FIG. 3 is a perspective view showing a configuration of each battery cell 100 included in battery module 1. Referring to FIG. 3, battery cell 100 includes electrode terminals 110, a case 120, a gas-discharge valve 130, and an electrode assembly 140.

Electrode terminals 110 are formed on case 120. Electrode terminals 110 have a positive electrode terminal 111 and a negative electrode terminal 112. Positive electrode terminal 111 and negative electrode terminal 112 are arranged side by side in the second direction (X direction).

Case 120 is a container that accommodates electrode assembly 140 and an electrolyte solution. Case 120 has a substantially rectangular parallelepiped shape. Case 120 is composed of aluminum, an aluminum alloy, iron, an iron alloy, or the like.

Case 120 has an upper surface 121, a lower surface 122, a pair of long side surfaces 123, and a pair of short side surfaces 124. Electrode terminals 110 are disposed on upper surface 121. Lower surface 122 is opposite to upper surface 121 in the third direction (Z direction).

The pair of long side surfaces 123 and the pair of short side surfaces 124 constitute side surfaces of case 120. The pair of long side surfaces 123 and the pair of short side surfaces 124 serving as the side surfaces of case 120 intersect each of upper surface 121 and lower surface 122. The pair of long side surfaces 123 are opposite to each other in the first direction (Y direction) with electrode assembly 140 being interposed therebetween. The pair of short side surfaces 124 are opposite to each other in the second direction (X direction) with electrode assembly 140 being interposed therebetween. Each of the pair of long side surfaces 123 has a larger area than that of each of the pair of short side surfaces 124.

Gas-discharge valve 130 is fractured when pressure inside case 120 becomes equal to or more than a predetermined value. Thus, gas in case 120 is discharged to outside of case 120.

Electrode assembly 140 functions as a power generation element. Electrode assembly 140 includes a positive electrode and a negative electrode (not shown). A substrate of the positive electrode is, for example, an aluminum alloy foil. A substrate of the negative electrode is, for example, a copper alloy foil. Electrode assembly 140 is, for example, a wound type electrode assembly in which the positive electrode and the negative electrode are wound or a stacked type electrode assembly in which the positive electrode and the negative electrode are alternately stacked.

### (Separator 400)

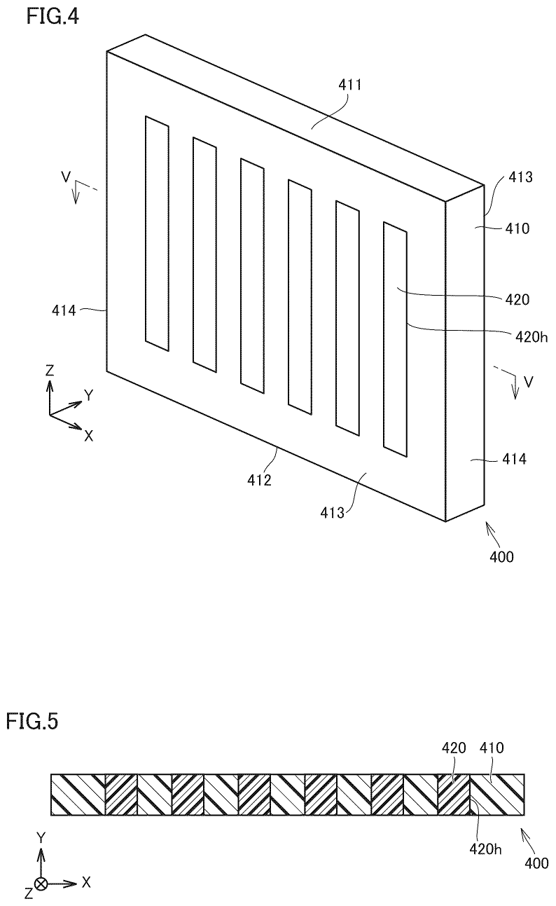

Next, a configuration of separator 400 will be described with reference to FIGS. 4 and 5. FIG. 4 is a perspective view showing the configuration of separator 400, and FIG. 5 is a cross sectional view along a line V-V in FIG. 4.

Separator 400 includes: a main body portion 410; and embedded portions 420 respectively embedded in a plurality of through holes 420h provided in main body portion 410. Main body portion 410 is a heat insulating material having heat insulating performance higher than that of embedded portion 420, and embedded portion 420 is an elastic material having elastic performance higher than that of the main body portion.

Main body portion 410 has an upper surface 411, a lower surface 412, a pair of long side surfaces 413, and a pair of short side surfaces 414. Lower surface 412 faces upper surface 411 in the third direction (Z direction).

The pair of long side surfaces 413 and the pair of short side surfaces 414 constitute side surfaces of separator 400. The pair of long side surfaces 413 and the pair of short side surfaces 414 as the side surfaces of separator 400 intersect each of upper surface 411 and lower surface 412. Each of the pair of long side surfaces 413 faces each other in the first direction (Y direction). Each of the pair of short side surfaces 414 faces each other in the second direction (X direction). Each of the pair of long side surfaces 413 has an area larger than that of each of the pair of short side surfaces 414.

The size and thickness of separator 400 may be such that separator 400 does not protrude with respect to battery cell 100 when compressed by battery cell 100. When separator 400 is compressed, the outer periphery of separator 400 is expanded, so that the size of separator 400 is preferably smaller than the size of battery cell 100. The thickness of separator 400 in the first direction (Y direction) is preferably about 0.5 mm to 10 mm.

Main body portion 410 of separator 400 is mainly required to have a function as a heat insulating material, and examples of a suitable material therefor include glass wool, rock wool, cellulose fiber, aerogel, a mixed shaped material of an inorganic filler and a binder, and a material obtained by solidifying an inorganic fiber and an inorganic powder.

In the present embodiment, each of embedded portions 420 of separator 400 has a shape of strip extending in the third direction (Z direction) when viewed in the first direction (Y direction), and embedded portions 420 are disposed at predetermined intervals in the second direction (X direction). In the present embodiment, each of embedded portions 420 is provided to be flush with the front surface side (side shown in the figure) of main body portion 410, and is also provided to be flush with the rear surface side (side opposite to the side shown in the figure) thereof.

Each of embedded portions 420 is mainly required to have a function as an elastic material, and examples of a suitable material therefor include silicone rubber, fluoro-rubber, urethane rubber, natural rubber, styrene-butadiene rubber, butyl rubber, ethylene propylene rubber (EPM, EPDM), butadiene rubber, isoprene rubber, norbornene rubber, and the like.

Furthermore, regarding selection of the materials of main body portion 410 and embedded portion 420, a material that is melted at a predetermined temperature or more is preferably selected for embedded portion 420 whereas a material that is not melted at the predetermined temperature or more is preferably selected for main body portion 410. Here, the predetermined temperature is assumed to be a temperature when battery cell 100 is brought into a high temperature state. In the high temperature state, the cell is considered to undergo thermal runaway, and 300 to 1000° C. or more is assumed. The EPDM (ethylene-propylene-diene rubber) can be selected as the embedded portion, and the aerogel or the like can be selected as the main body portion.

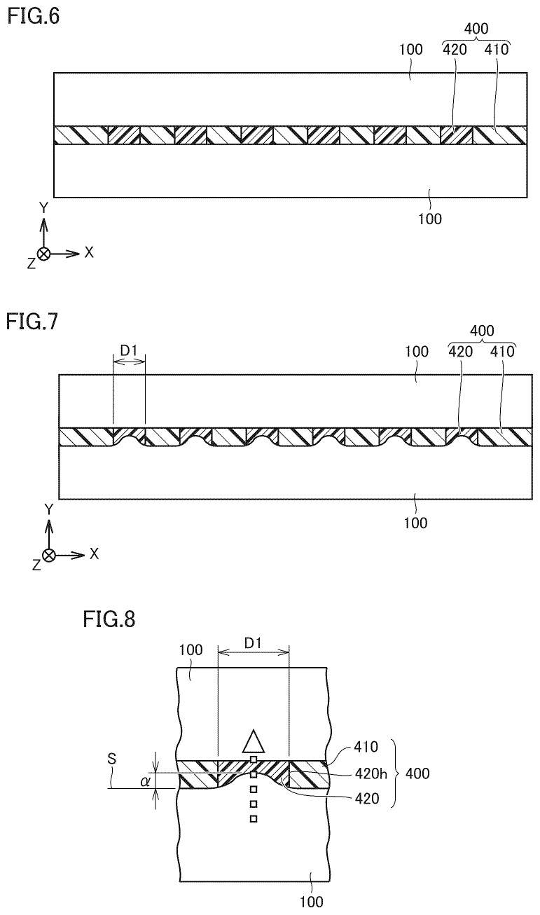

Next, referring to FIGS. 6 and 7, the following describes states in each of which separator 400 is sandwiched between battery cells 100. FIG. 6 is a schematic diagram showing a state (first state) in which a battery cell 100 is in a normal state, and FIG. 7 is a schematic diagram showing a state (second state) in which a battery cell 100 is in an expansion state. For convenience of illustration, each of FIGS. 6 and 7 shows a state in which one separator 400 is sandwiched between two battery cells 100.

As shown in FIG. 6, in the state in which battery cell 100 is not expanded, there is no change in separator 400. As shown in FIG. 7, in the state in which battery cell 100 shown in the figure is expanded, battery cell 100 is expanded to the through hole 420h side because embedded portion 420 is more elastic than main body portion 410. Thus, even when battery cell 100 is expanded, separator 400 can absorb the expansion of battery cell 100.

Even if embedded portion 420 is melted due to heat generation of battery cell 100 and ceases to exist, main body portion 410 remains and a load generated by the expansion of battery cell 100 can be therefore supported by main body portion 410. Therefore, a total required area of the side surfaces of main body portion 410 facing battery cells 100 should be designed in consideration of the case where embedded portion 420 ceases to exist.

### (Relation Between Amount of Deformation of Battery Cell 100 and Hole Diameter of Through Hole 420h)

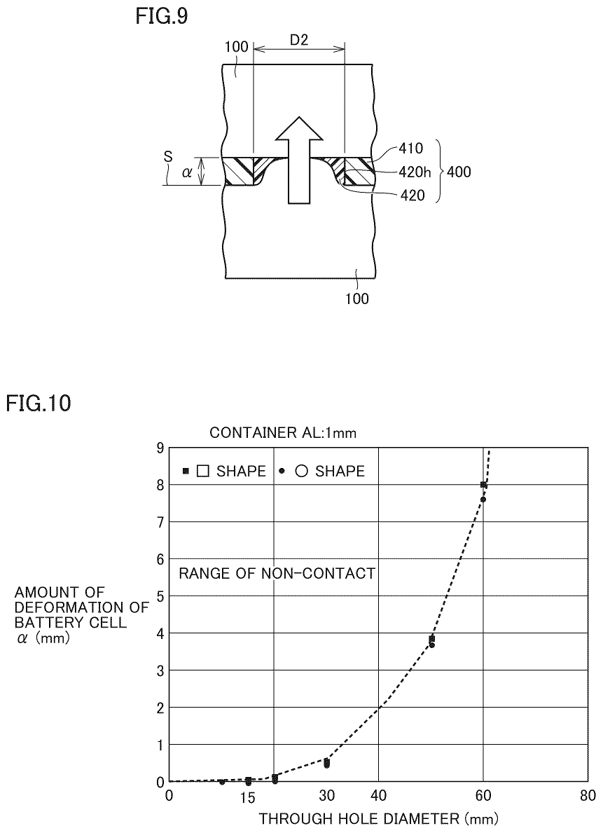

Next, a relation between an amount of deformation of battery cell 100 and a hole diameter of through hole 420h will be reviewed with reference to FIGS. 8 to 10. Here, the maximum diameter of the hole diameter of through hole 420h in the first embodiment means a hole diameter in the second direction (X direction), rather than a hole diameter in the third direction (Z direction). FIGS. 8 and 9 are first and second schematic cross sectional views each showing the relation between the amount of deformation of the battery cell and the hole diameter of the through hole, and FIG. 10 is a diagram showing the relation between the diameter of through hole 420h and the amount of deformation of the battery cell.

Referring to FIG. 8, the following describes a case where the relation between the amount of deformation of battery cell 100 and the hole diameter (D1) of through hole 420h is appropriate. In the state shown in FIG. 8, even when battery cell 100 is expanded to the through hole 420h side, the expanded portion of battery cell 100 is not brought into contact with opposing battery cell 100. Thus, even when battery cell 100 is expanded, battery cell 100 is not brought into contact with opposing battery cell 100, thereby preventing a decrease in thermal resistance. Even if embedded portion 420 ceases to exist, the space of through hole 420h remains, thereby preventing heat transfer to the opposing battery cell.

Referring to FIG. 9, the following describes a case where the relation between the amount of deformation of battery cell 100 and the hole diameter (D2) of through hole 420h is inappropriate. In the state shown in FIG. 9, battery cell 100 is expanded to the through hole 420h side, and the expanded portion of battery cell 100 is brought into contact with opposing battery cell 100. Thus, when battery cell 100 is expanded to come into contact with opposing battery cell 100, the thermal resistance is decreased to directly transfer heat to opposing battery cell 100, with the result that opposing battery cell 100 is adversely affected by the heat.

Here, referring to FIG. 10, the following describes the relation between through hole 420h and the amount of deformation of battery cell 100. The inner diameter of the through hole described below means a distance between one portion of the inner wall surface of the through hole and another portion of the inner wall surface of the inner diameter of the through hole, the other portion of the inner wall surface being located in a direction perpendicular to the one portion of the inner wall surface. Here, it is assumed that case 120 of battery cell 100 is a container composed of aluminum and having a thickness of 1 mm, and gas-discharge valve 130 is operated at 1 MPa. Therefore, it is assumed that the internal pressure of battery cell 100 is 1 MPa. Review was conducted with each of a quadrangular shape (mark in the figure) and a circular shape (O mark in the figure) being employed as the shape of through hole 420h. As shown in FIGS. 8 and 9, regarding the amount of deformation of battery cell 100, an amount of expansion with respect to a contact surface between battery cell 100 and separator 400 was defined as an amount of deformation (a) mm.

As shown in FIG. 10, when the inner diameter (mm) of the through hole is increased, the amount of deformation (α) of battery cell 100 is increased. When the thickness of separator 400 is increased, the number of battery cells 100 that can be mounted on battery module 1 is decreased, thus resulting in a decreased energy density. Therefore, 10 mm or less is preferable. Hence, the amount of deformation (α) mm of battery cell 100 is preferably 9 mm or less from the viewpoint of avoiding contact with opposing battery cell 100.

As a result, the inner diameter of through hole 420h is preferably 60 mm or less. Each of the quadrangular shape (□ mark in the figure) and the circular shape (O mark in the figure) was employed as the shape of through hole 420h, and the same amount of deformation (α) mm was obtained in each of the cases of the both shapes.

In consideration of a case where rigidity of case 120 is decreased due to a high temperature and main body portion 410 is compressed by increased load to result in a shorter distance between battery cells 100 than expected when battery cell 100 is deformed, the inner diameter of through hole 420h is preferably 30 mm or less such that the amount of deformation (α) of battery cell 100 becomes 1 mm or less.

Further, when embedded portion 420 does not completely cease to exist and is decreased in volume, the inner diameter of through hole 420h is more preferably 15 mm or less such that the amount of deformation (α) mm becomes 0.1 mm or less in order to form a clearance between embedded portion 420 and battery cell 100 to increase the heat insulating effect.

In view of the above, although various shapes can be considered for the through hole, it is preferable that the shortest distance between the one portion of the inner wall surface of the inner diameter of the through hole and the other portion of the inner wall surface of the inner diameter of the through hole is 60 mm or less, the other portion of the inner wall surface being located in the direction perpendicular to the one portion of the inner wall surface.

Hereinafter, modifications of the first embodiment will be described. In each of the embodiments described below, the shape of the separator will be described and the same explanation will not be described repeatedly because the configurations of battery module 1 and battery cell 100 are basically the same.

### Second Embodiment

A separator 400A according to a second embodiment will be described with reference to FIG. 11. FIG. 11 is a cross sectional view showing a configuration of separator 400A, and corresponds to the cross section along line V-V in FIG. 4.

Separator 400A in the present embodiment has such a shape that embedded portion 420 protrudes (length d) with respect to the surface of main body portion 410 in the first direction (Y direction). Therefore, in the first direction (Y direction), the length of embedded portion 420 is longer than the length of main body portion 410. Also in separator 400A in which embedded portion 420 thus protrudes (length d) with respect to the surface of main body portion 410, the same functions and effects as those of the first embodiment can be obtained.

Furthermore, as the protrusion is larger, a range of elasticity of embedded portion 420 can be large, thereby attaining an increased effect of cushioning the reaction force of battery cell 100. Thus, the strength of the restraint member such as end plate 200 can be decreased, with the result that the weight of the module can be reduced. Further, by changing the size of the through hole in the separator, the size of the embedded portion can be changed to change the elasticity in the separator, with the result that the elasticity in the separator can be changed depending on locations in response to the expansion of the battery cell.

### Third Embodiment

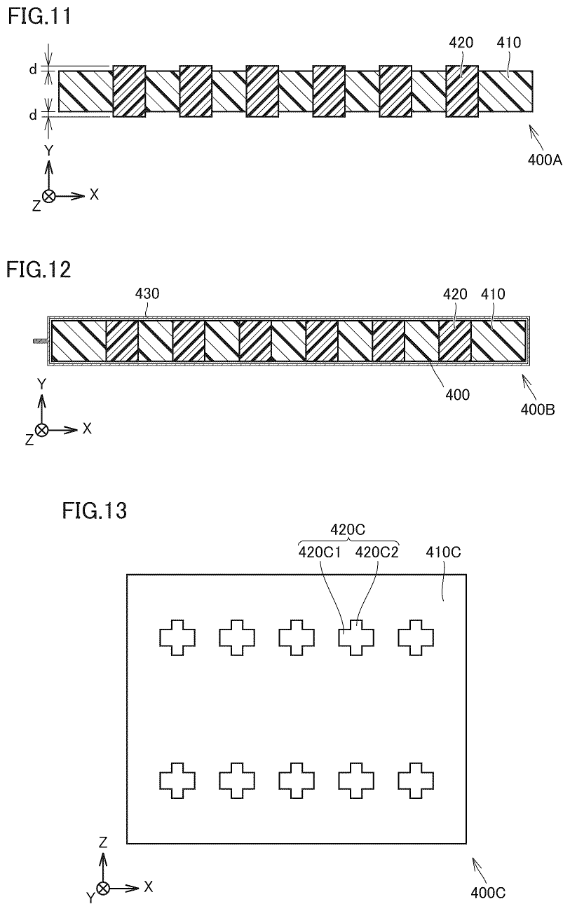

A separator 400B according to a third embodiment will be described with reference to FIG. 12. FIG. 12 is a cross sectional view showing a configuration of separator 400B, and corresponds to the cross section along line V-V in FIG. 4.

The entire periphery of separator 400B in the present embodiment is covered with a laminate film 430. Examples of laminate film 430 include PET (polyethylene terephthalate), PE (polyethylene), PP (polypropylene), vinyl chloride (polyvinyl chloride), PO (polyolefin), and the like.

Also in separator 400B thus having its entire periphery covered with laminate film 430, the same functions and effects as those of the first embodiment can be obtained. Furthermore, since separator 400B is covered with laminate film 430, the embedded portion can be prevented from being detached from the main body portion during a process such as module assembling.

### Fourth Embodiment

A separator 400C according to a fourth embodiment will be described with reference to FIG. 13. FIG. 13 is a side view of separator 400C when viewed in the first direction (Y direction). Separator 400C in the present embodiment has a main body portion 410C and a plurality of embedded portions 420C. Each of embedded portions 420C is shaped to have a cross shape and has a first region 420C1 extending in the second direction (X direction) and a second region 420C2 extending in the third direction (Z direction). In the present embodiment, embedded portions 420C are disposed in two rows and five columns, but the number of the embedded portions disposed is not limited thereto. Further, embedded portions 420C may be arranged in the form of a houndstooth check.

The same functions and effects as those of the first embodiment can also be obtained in separator 400C having such a shape. Further, the sides of each of the embedded portions can be made long to increase the strength of embedding in the main body portion, thereby preventing detachment. Further, the diameter of the embedded portion can be made small to prevent contact with the opposing battery cell at the time of expansion of the cell.

### Fifth Embodiment

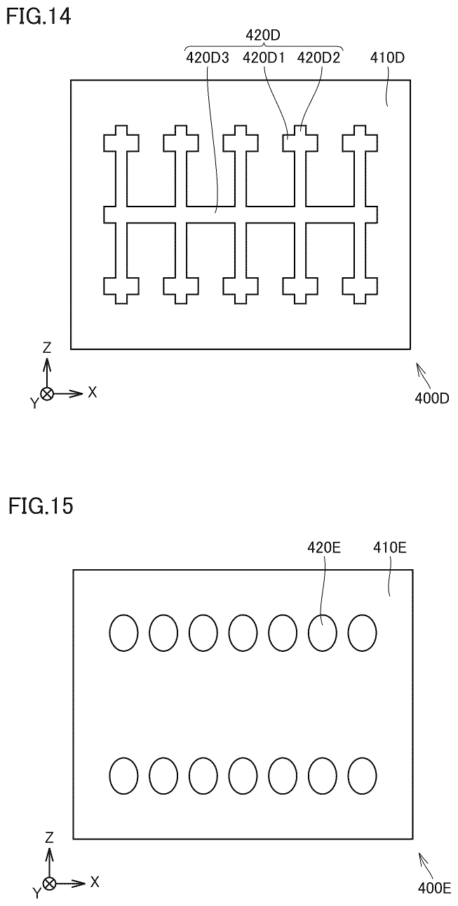

A separator 400D according to a fifth embodiment will be described with reference to FIG. 14. FIG. 14 is a side view of separator 400D when viewed in the first direction (Y direction).

Separator 400D in the present embodiment has a main body portion 410D and an embedded portion 420D. Embedded portion 420D is shaped to have cross shapes defined by main body portion 410D, first regions 420D1 each extending in the second direction (X direction), and second regions 420D2 each extending in the third direction (Z direction), and second regions 420D2 of embedded portion 420D located at the upper and lower sides communicate with each other. Further, one third region 420D3 extending in the second direction (X direction) passes through the central portions of second regions 420D2 located at the upper and lower sides and communicating each other.

The same functions and effects as those of the first embodiment can also be obtained in separator 400D having such a shape. Further, as with the fourth embodiment, the strength of embedding in the main body portion can be increased to prevent detachment and the diameter of the embedded portion can be made small to prevent contact with the opposing battery cell at the time of expansion of the cell. Furthermore, since the plurality of first regions 420D1 and the plurality of second regions 420D2 are connected by third region 420D3, embedded portion 420D is a component in one piece. A through hole corresponding to embedded portion 420D is a through hole in one piece, thereby simplifying the process of assembling the embedded portion and the main body portion.

### Sixth Embodiment

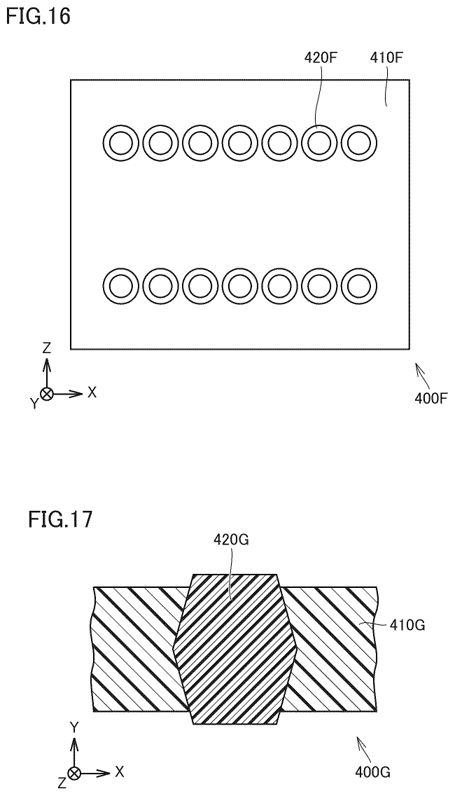

A separator 400E according to a sixth embodiment will be described with reference to FIG. 15. FIG. 15 is a side view of separator 400E when viewed in the first direction (Y direction).

Separator 400E in the present embodiment has a main body portion 410E and a plurality of embedded portions 420E. Each of embedded portions 420E is solid and has an elliptical shape having a major axis in the third direction (Z direction). In the present embodiment, embedded portions 420E are disposed in two rows and seven columns, but the number of the embedded portions disposed is not limited thereto. Further, embedded portions 420C may be disposed in the form of a houndstooth check. The major axis direction of the ellipse is not limited to the third direction (Z direction), and may be oriented in any direction.

The same functions and effects as those of the first embodiment can also be obtained in separator 400E having such a shape.

### Seventh Embodiment

A separator 400F according to a seventh embodiment will be described with reference to FIG. 16. FIG. 16 is a side view of separator 400F when viewed in the first direction (Y direction).

Separator 400F has a main body portion 410F and embedded portions 420F. Each of embedded portion 420F has a hollow cylindrical shape. Regarding the manner of arrangement and number of the embedded portions, the embedded portions can be arranged in 2 rows and 5 columns as illustrated in the fourth embodiment of FIG. 13 or in 2 rows and 7 columns as illustrated in the sixth embodiment of FIG. 15, the other number of the embedded portions can be arranged, the embedded portions can be arranged in the form of a houndstooth check, or the embedded portions can be arranged in other various manners.

The same functions and effects as those of the first embodiment can also be obtained in separator 400F having such a shape. Further, since an amount of resin in the case of the hollow embedded portion is smaller than that in the case of the solid embedded portion, a space accordingly secured can be increased. Further, even when the embedded portion is melted, a space can be formed, thereby securing thermal resistance for an adjacent battery cell.

### Eighth Embodiment

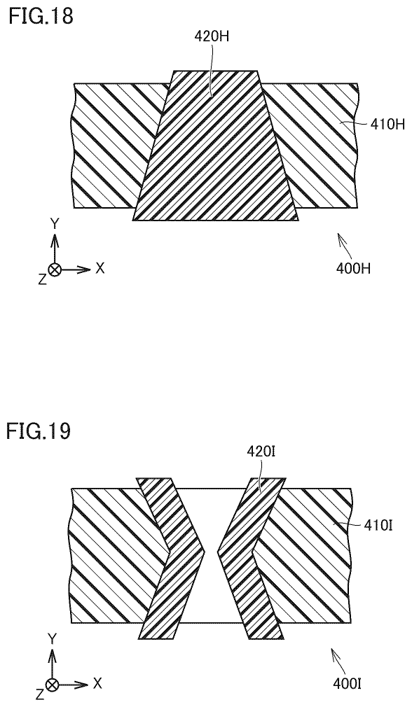

A separator 400G according to an eighth embodiment will be described with reference to FIG. 17. FIG. 17 is a cross sectional view of separator 400G when viewed in the third direction (Z direction), and only shows one embedded portion 420G employed in separator 400G.

Separator 400G in the present embodiment has a main body portion 410G and a plurality of embedded portions 420G. Each of embedded portions 420G is solid and has a substantially barrel shape having an outer diameter that is the largest at its central portion with the outer diameter being decreased toward both ends. Regarding the manner of arrangement and number of the embedded portions, the embedded portions can be arranged in 2 rows and 5 columns as illustrated in the fourth embodiment of FIG. 13 or in 2 rows and 7 columns as illustrated in the sixth embodiment of FIG. 15, the other number of the embedded portions can be arranged, the embedded portions can be arranged in the form of a houndstooth check, or the embedded portions can be arranged in other various manners.

The same functions and effects as those of the first embodiment can also be obtained in separator 400G having such a shape. Further, the projecting portion applies a load to the main body portion in the X direction, thereby causing frictional force between the main body portion and the embedded portion. As a result, coupling force between the main body portion and the embedded portion is increased, thereby preventing the embedded portion from being detached from the main body portion during the process.

### Ninth Embodiment

A separator 400H according to a ninth embodiment will be described with reference to FIG. 18. FIG. 18 is a cross sectional view of separator 400H when viewed in the third direction (Z direction), and only shows one embedded portion 420H employed in separator 400H.

Separator 400H in the present embodiment has a main body portion 410H and a plurality of embedded portions 420H. Each of embedded portions 420H is solid and is shaped to have a truncated cone shape having an outer diameter that is decreased from one end side toward the other end side. Regarding the manner of arrangement and number of the embedded portions, the embedded portions can be arranged in 2 rows and 5 columns as illustrated in the fourth embodiment of FIG. 13 or in 2 rows and 7 columns as illustrated in the sixth embodiment of FIG. 15, the other number of the embedded portions can be arranged, the embedded portions can be arranged in the form of a houndstooth check, or the embedded portions can be arranged in other various manners.

The same functions and effects as those of the first embodiment can also be obtained in separator 400H having such a shape. Further, since one side of the embedded portion is smaller, the embedded portion can be readily installed in the main body portion, advantageously. Further, since the other side of the embedded portion is larger than the hole of the main body portion, the main body portion and the embedded portion are lightly press-fitted to each other, thereby preventing detachment.

### Tenth Embodiment

A separator 400I according to a tenth embodiment will be described with reference to FIG. 19. FIG. 19 is a cross sectional view of separator 400I when viewed in the third direction (Z direction), and only shows one embedded portion 420I employed in separator 400I.

Separator 400I in the present embodiment has a main body portion 410I and a plurality of embedded portions 420I. Each of embedded portions 420I is hollow and has a substantially shape of Japanese drum, which is called Tsuzumi, having an outer diameter that is the smallest at its central portion with the outer diameter being increased toward both ends. Regarding the manner of arrangement and number of the embedded portions, the embedded portions can be arranged in 2 rows and 5 columns as illustrated in the fourth embodiment of FIG. 13 or in 2 rows and 7 columns as illustrated in the sixth embodiment of FIG. 15, the other number of the embedded portions can be arranged, the embedded portions can be arranged in the form of a houndstooth check, or the embedded portions can be arranged in other various manners.

The same functions and effects as those of the first embodiment can also be obtained in separator 400I having such a shape. Further, not only a space is provided between the separator and the adjacent battery cell to secure thermal resistance when the embedded portion is melted, but also the embedded portion is less likely to be detached from the main body portion because the embedded portion is larger on the outer surface side of the main body portion than on the inner side of the main body portion. Further, the embedded portions may be connected together by a flat base member thinner than the heat-resistant layer (main body portion), and the embedded portions may be in one piece with each other. Thus, the embedded portions are less likely to be detached during the process, and the assembling of the embedded portions and the main body portion can be simplified.

Each of the modifications of the separators as shown in the above-described second to tenth embodiments has a configuration based on the configuration of the first embodiment, but may have a configuration not based on the configuration of the first embodiment.

In each of the embodiments, the separator disposed between the plurality of battery cells has been described; however, the same configuration as that of the above-described separator can also be applied to the separator disposed between the battery cell and the end plate. Further, in the present specification, the expression “the same size” means that the sizes of the design values are the same with no manufacturing tolerance being included.

Although the embodiments of the present invention have been described and illustrated in detail, it is clearly understood that the same is by way of illustration and example only and is not to be taken by way of limitation. The scope of the present invention is defined by the terms of the claims, and is intended to include any modifications within the scope and meaning equivalent to the terms of the claims.

What is claimed is:

1. A battery module comprising:
a plurality of battery cells arranged side by side in a first direction; and
a separator sandwiched between the plurality of battery cells, wherein
the separator includes
a main body portion, and
an embedded portion embedded in each of a plurality of through holes provided in the main body portion,
the main body portion is a heat insulating material having heat insulating performance higher than heat insulating performance of the embedded portion,
the embedded portion is an elastic material having elastic performance higher than elastic performance of the main body portion, and
a shortest distance between one portion of an inner wall surface of an inner diameter of the through hole and another portion of the inner wall surface of the inner diameter of the through hole is 60 mm or less, the other portion of the inner wall surface being located in a direction perpendicular to the one portion of the inner wall surface.

2. The battery module according to claim 1, wherein a length of the embedded portion is longer than a length of the main body portion in the first direction.

3. The battery module according to claim 1, wherein the embedded portion is melted at a predetermined temperature or more, and the main body portion is not melted at the predetermined temperature or more.

4. The battery module according to claim 1, wherein when viewed in the first direction, the embedded portion is shaped to have any of a solid circular shape, a solid elliptical shape, a solid cross shape, a hollow circular shape, or a hollow elliptical shape.

5. The battery module according to claim 1, wherein when viewed in the first direction, the embedded portion is shaped to have a first region and a second region, the first region extending in a second direction included in an imaginary plane orthogonal to the first direction when viewed in the imaginary plane, the second region extending in a third direction included in the imaginary plane and orthogonal to the second direction.

6. The battery module according to claim 1, wherein the separator is covered with a laminate film.
